(19) United States
(12) Patent Application Publication
(10) Pub. No.: US 2026/0154119 A1
(43) Pub. Date: Jun. 4, 2026

(54) METHODS, SYSTEMS AND DEVICES FOR DETERMINING COMPUTING RESOURCES FOR A USER

(71) Applicant: JPMorgan Chase Bank, N.A., New York, NY (US)

(72) Inventors: Camilla Bressan, LONDON (GB); Andrew R. Scott, Market Harborough (GB); Nick Helmstetter, Delaware, OH (US); Jeremy Johnston, Delaware, OH (US); Alex Turney, Columbus, OH (US); Bryan Dagostino, Delaware, OH (US); Kin Au, Lewis Center, OH (US); Jhin Choe, Dublin, OH (US); Abhishek Mahajan, Powell, OH (US); Rocky J. Maufort, Delaware, OH (US)

(73) Assignee: JPMorgan Chase Bank, N.A., New York, NY (US)

(21) Appl. No.: 19/407,673

(22) Filed: Dec. 3, 2025

Related U.S. Application Data
(60) Provisional application No. 63/727,248, filed on Dec. 3, 2024.

(51) Int. Cl. G06F 9/50

(52) U.S. Cl. CPC G06F 9/5027

(57) ABSTRACT

Aspects of the subject disclosure may include, for example, determining a user score associated with a first user utilizing a machine learning (ML) software application implementing a first ML model, receiving a request for an amount of computing resources from a computing device associated with the first user, and determining the amount of computing resources based on a plurality of properties including the user score accessed from a graph database utilizing a second ML model. Further embodiments include identifying allocated computing resources associated with a first virtual machine based on the amount of computing resources utilizing a linear programming software application and providing access to the allocated computing resources to the first user via the computing device. Other embodiments are disclosed.

### CROSS-REFERENCE TO RELATED APPLICATION

This application claims the benefit of and priority to U.S. Provisional Ser. No. 63/727,248, filed Dec. 3, 2024. All sections of the aforementioned application are incorporated by reference herein in their entirety.

### FIELD OF THE DISCLOSURE

The subject disclosure relates to methods, systems, and devices for determining computing resources for a user.

### BACKGROUND

When utilizing cloud computing resources, users may select a particular type of instance of computing resources, fleet of instances, and/or services to conduct a particular task or application. Some cloud providers may give the option of selecting a serverless service, meaning that the underlying infrastructure is managed by the cloud provider itself. In any of these use case scenarios, the type of instances (e.g., processor capacity, memory capacity, etc.) is to be specified. Some cloud providers may account for the possibility of varying workload of an instance, allowing for what is generally referred to as horizontal autoscaling. This service may create multiple virtual machines of the same type (e.g., up to a certain maximum number specified by the user) on one or more cloud servers according to workload, for example.

It may be difficult to change the virtual machine specifications (e.g., directly). The user may pay a fixed cost for computing resources based on the machine specifications and/or may need to trade-off between computing resources required to conduct their particular task or application and the costs of those computing resources. The user selects (e.g., or an administration system assigns) a virtual machine type that is optimal only in the majority of the situations for the user. This may result in allocated computing resources being utilized sub-optimally or stretched to the point where the user experience is poor and the particular task or application may not be completed. If the user requires changes in the virtual machine type (e.g., processor capacity, memory capacity, etc.), the process is manual. That is, the user may need to backup the data, stop the processing of the virtual machine, rescale the virtual machine, and/or start the virtual machine again with the rescaling of its computing resources. This process may be time consuming, involve downtime, and/or depend on the judgement of the user of which virtual machine type may be needed subsequently. Depending on the user experience and/or familiarity with the cloud computing resources, the user may under-provision or over-provision computing resources. This leads to the user having a poor experience (e.g., in the under-provisioning situation) or rendering an overpayment for computing resources (in the over-provisioning situation). The virtual machine type may not be optimal for the required workload for the user's particular task or application.

### SUMMARY OF THE DISCLOSURE

The subject disclosure describes, among other things, illustrative embodiments for determining a user score associated with a first user utilizing a machine learning (ML) software application implementing a first ML model, receiving a request for an amount of computing resources from a computing device associated with the first user, and determining the amount of computing resources based on a plurality of properties including the user score accessed from a graph database utilizing a second ML model. Further embodiments may include identifying allocated computing resources associated with a first virtual machine based on the amount of computing resources utilizing a linear programming software application, and providing access to the allocated computing resources to the first user via the computing device.

One or more aspects of the subject disclosure include a device, comprising a processing system including a processor, and a memory that stores executable instructions that, when executed by the processing system, facilitate performance of operations. The operations may comprise determining a user score associated with a first user utilizing a machine learning software application implementing a first ML model, and receiving a request for an amount of computing resources from a computing device associated with the first user. Further operations may comprise determining the amount of computing resources based on a plurality of properties including the user score accessed from a graph database utilizing a second ML model, identifying allocated computing resources associated with a first virtual machine based on the amount of computing resources utilizing a linear programming software application, and providing access to the allocated computing resources to the first user via the computing device.

One or more aspects of the subject disclosure include a non-transitory machine-readable medium, comprising executable instructions that, when executed by a processing system including a processor, facilitate performance of operations. The operations may comprise determining a user score associated with a first user utilizing a machine learning software application implementing a first ML model, receiving a request for an amount of computing resources from a computing device associated with the first user, and determining the amount of computing resources based on a plurality of properties including the user score accessed from a graph database utilizing a second ML model. Further operations may comprise identifying allocated computing resources associated with a first virtual machine based on the amount of computing resources utilizing a linear programming software application, and providing access to the allocated computing resources to the first user via the computing device.

One or more aspects of the subject disclosure include a method. The method may comprise determining, by a processing system including a processor, a user score associated with a first user utilizing a machine learning software application implementing a first ML model, receiving, by the processing system, a request for an amount of computing resources from a computing device associated with the first user, and determining, by the processing system, based on a plurality of properties include the user score an estimated amount of computing resources. Further, the method may comprise determining, by the processing system, a plurality of available computing resources based on availability plurality of virtual machines, identifying, by the processing system, first available computing resources associated with a first virtual machine is more than the estimated amount of computing resources, the plurality of available computing resources comprises the first available computing resources, the plurality of virtual machines comprises the first virtual machine, determining, by the processing system, allocated computing resources associated with the first virtual machine based on the first available computing resources and the estimated amount of computing resources, and providing, by the processing system, access to the allocated computing resources to the first user via the computing device.

### BRIEF DESCRIPTION OF THE DRAWINGS

Reference is now be made to the accompanying drawings, which are not necessarily drawn to scale, and wherein:

FIG. 1A is a block diagram illustrating an example, non-limiting embodiment of a system functioning in accordance with various aspects described herein.

FIG. 1B depicts an illustrative embodiment of a method in accordance with various aspects described herein.

FIGS. 2A-2D are block diagrams illustrating example, non-limiting embodiments of a system functioning in accordance with various aspects described herein.

FIG. 2E depicts an illustrative embodiment of a method in accordance with various aspects described herein.

FIGS. 3A-3D are block diagrams illustrating example, non-limiting embodiments of a system functioning in accordance with various aspects described herein.

FIG. 3E depicts an illustrative embodiment of a method in accordance with various aspects described herein.

FIG. 4 is a block diagrams illustrating an example, non-limiting embodiment of a system functioning in accordance with various aspects described herein.

FIG. 5 depicts an illustrative embodiment of a method in accordance with various aspects described herein.

FIG. 6 is a block diagram of an example, non-limiting embodiment of a computing environment in accordance with various aspects described herein.

FIG. 7 is a block diagram of an example, non-limiting embodiment of a mobile network platform in accordance with various aspects described herein.

FIG. 8 is a block diagram illustrating an example, non-limiting embodiment of a system functioning in accordance with various aspects described herein.

### DETAILED DESCRIPTION

One or more embodiments may include a plurality of users having access to one or more virtual machines to conduct a particular task or application. Different virtual machines may have different amounts of available computing resources. Further embodiments may attempt to provide users with access to certain virtual machines to efficiently and/or cost-effectively utilize the virtual machines. This may include determining computing resources for a user to conduct a particular task or application based on a user score utilizing a one or more ML models and/or efficiently assigning a virtual machine to the user, accordingly. More specifically, a server may receive a request for computing resources for a particular task or application to be conducted by a user, and, in response, may determine computing resources for the user to conduct the particular task or application (e.g., provisioning a database, developing a user interface, etc.) utilizing a computing resources recommendation system. The computing resources recommendation system may determine the computing resources based on a user score determined by a user score calculation system. Further, the user score may be associated with one or more machine properties such as historical usage of computing resources for the particular task or application, historical usage of computing resources generally, etc. The user score may be associated with an estimated or predicted amount of computing resources. Further, a virtual machine assignment system may determine available computing resources of one or more virtual machines provisioned on one or more servers and/or identifying computing resources on one of these virtual machines to assign to the user based on the computing resources determined by the computing resources recommendation system. In some embodiments, the virtual machine assignment system may provide access to the computing resources on a particular virtual machine to the user and the user may accept (e.g., provide user-generated input to select) such access. In other embodiments, the virtual machine assignment system may assign (e.g., provide access) the computing resources on the virtual machine to the user, without providing a recommendation (e.g., notification) or user acceptance (e.g., user-generated input). Thus, embodiments described herein may provide an efficient manner in which to determine the amount of computing resources to conduct a particular task or application and/or provide access to one or more virtual machines having at least the amount of computing resources to a user to efficiently or optimally utilize available computing resources associated with the virtual machines.

One or more embodiments may include a vertical autoscaling process for cloud providers and/or managed computer networks. The vertical autoscaling process may utilize an automated user score calculation system, automated computing resources recommendation system, and/or a virtual machine assignment system for selecting or otherwise determining a virtual machine type based on various factors/properties including a user's past utilization of computing resources and/or the user's computing resources requirements for a particular task or application. Further embodiments utilize linear programming for the virtual machine assignment system to seamlessly assign users within and/or across data centers to a location.

One or more embodiments may comprise a user score calculation system that includes an ML software application utilizing a first plurality of ML models trained on the past utilization of selected computing resources by the user. The first plurality of ML models may be used to predict future utilization as well as determine whether the virtual machine may be underutilized or overutilized. Reference to this estimate may be as a user score. Some embodiments may monitor the execution of the user's applications and/or computing resources as well as determine an associated score utilizing another ML model, which may be referenced as an application score. An application score may be used to determine application compatibility with the virtual machine type.

One or more embodiments may include collecting relevant data associated with a user, user requirements, among which, for example, may include the maximum constraints imposed by the user, and/or applications in a graph database, using a resource description framework (RDF) data model. Further embodiments may add the user score and/or application score computed as user properties in the graph database. The graph network representation (e.g., the graph database) may allow computing sophisticated representations of the nodes of the graph (e.g., vector node embeddings) that enables the computer resources recommendation system to estimate the computer resources needed by a user and/or enable the virtual machine assignment system to suggest the optimal virtual machine type for a user. The estimate of computer resources provided by the computer resources recommendation system includes being tied to the past utilizations given by the user score as well as to all the related connections shown by the graph data structure, as, for example, the similarities between users (e.g. their hierarchy), and to the application compatibility shown by the application score. Incorporating such a paradigm may allow for the recommendation of computing resources for a new user, despite the lack of historical information.

One or more embodiments may include the user being seamlessly allocated to a virtual machine type that more accurately fits their requirements, in a particular rack of a given cluster of virtual machines, in an optimal way, by utilizing a linear programming software application (e.g., a software application implementing a linear programming model associated with assigning a user to a virtual machine type that accurately estimates its computing resources needs) by the virtual machine assignment system. This may be achieved by maximizing the workload of the user's particular task or application across the minimal (or reduced) number of virtual machines in the cluster, and/or maximizing (or increasing) user experience (e.g., taking into account the user score). This is significant if users happen to share computing resources on the same virtual machine with other users, in which case the respective users scores need to be compatible, to guarantee the best experience for all users simultaneously.

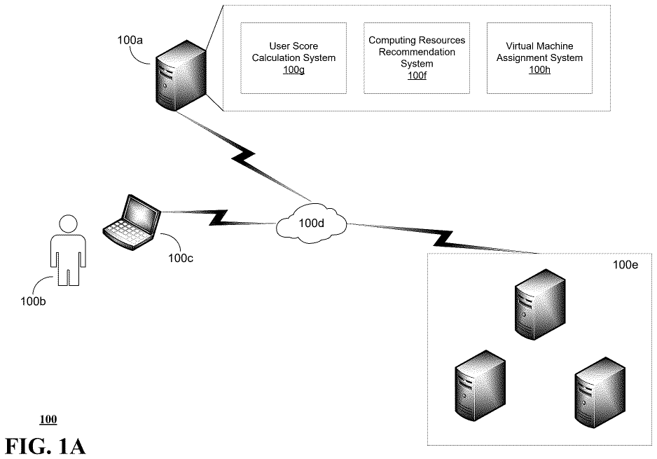

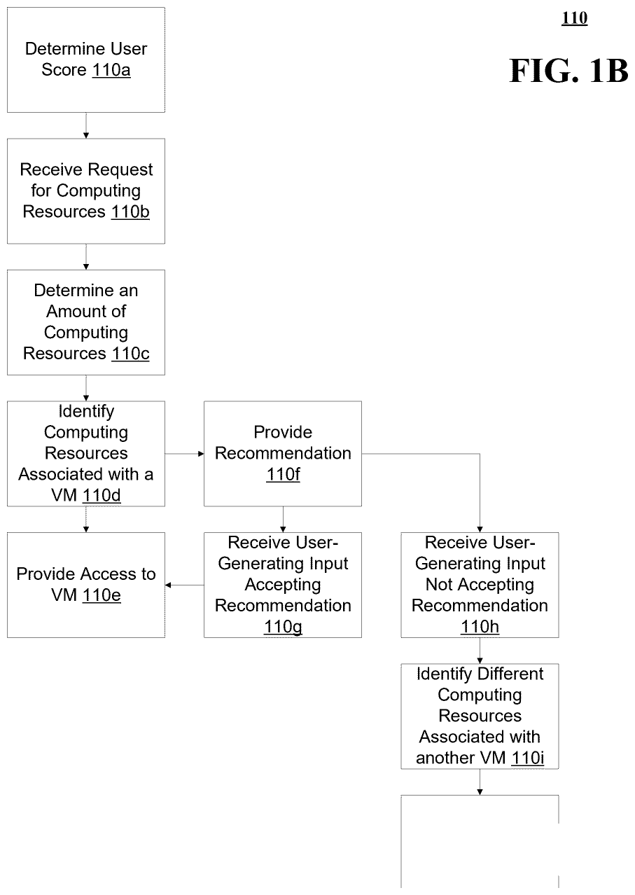

Referring to FIG. 1A, in one or more embodiments, system 100 may include a server 100a that implements a user score calculation system 100g, a computing resources recommendation system 100f, and a virtual machine assignment system 100h. In one or more embodiments, each of user score calculation system 100g, the computing resources recommendation system 100f, and the virtual machine assignment system 100h may be implemented via hardware, software, virtual network functions, and/or a combination thereof, which may be facilitated by server 100a. Further, the system 100 may include a computing device 100c associated with user 100b that is communicatively coupled to server 100a over communication network 100d. System 100 may include a plurality of servers 100e in which virtual machines may be instantiated to be available as computing resources for user 100b to conduct a particular task (e.g., provision a database) or application (e.g., developing a user interface). The user score calculation system 100g may determine a user score for user 100b by utilizing a ML software application utilizing a first plurality of ML models. These first plurality of ML models may include a DeepAR model, the Long Short-Term Memory (LSTM) model, the Temporal Fusion Transformer (TFT), Neural Basis Expansion Analysis for Time Series Forecasting (Nbeats), and/or Neural Hierarchical Interpolation for Time Series Forecasting (NHiTS). The DeepAR model may be a supervised learning ML model that uses recurrent neural networks (RNN) to make predictions. The LSTM mode may be another type of RNN ML model. The TFT model may be a neural network ML model that uses a transformer architecture to make predictions. Nbeats may employ a series of feed-forward neural networks to make predictions. NHiTs may implement a way of hierarchical synchronizing the rate of input sampling with scale of output interpolation across blocks, which induces each block to specialize in making its own predictions. The computing resources recommendation system 100f on server 100a may receive a request for computing resources from computing device 100c, via user-generated input by user 100b, over the communication network 100d for the particular task or application. Further, the computing resources recommendation system 100f may determine an amount of computing resources for user 100b based on the user score (among other properties described herein) utilizing a ML software application implementing a second plurality of ML models. The second plurality of ML models may include graph neural networks (GNNs) that are applied to a graph database storing the user score and/or other properties associated with user 100b to estimate an amount of computer resources for user 100b. The virtual machine assignment system 100h on server 100a may identify computing resources associated with a virtual machine instantiated on one or more servers 100e based on the amount of computing resources determined by the computer resources recommendation system 100f. The virtual machine assignment system 100h may provide the user 100b access to the virtual machine instantiated on servers 100e, as described herein.

In further embodiments, the computing resources recommendation system 100f on server 100a may provide computing device 100c with a recommendation of computing resources (e.g., a notification, message, etc. indicating the computing resources) for user 100b that is displayed by computing device 100c to the user 100b. In response, the user 100b may provide user-generated input that is sent to the server 100a over communication network 100d via computing device 100c that indicates accepting and/or selecting the recommended computing resources. In response to receiving the user-generated input, the virtual machine assignment system 100h on server 100a may identify and then provide access to user 100b via computing device 100c to the computing resources on one of the virtual machines on servers 100e.

In other embodiments, the computing resources recommendation 100f on server 100a may provide computing device 100c a recommendation of computing resources (e.g., a notification, message, etc. indicating the computing resources) that is displayed by computing device 100c to the user 100b. In response, the user 100b may provide user-generated input that is sent to the server 100a over communication network 100d via computing device 100c that indicates not accepting and/or selecting the recommended computing resources and/or indicates a different amount of computing resources (e.g., different amount processing capacity, different amount of memory capacity, etc.). In response to receiving the user-generated input, the virtual machine assignment system 100f on server 100a may then identify whether the different amount of computing resources is available on one or more virtual machines of servers 100e and may provide access to user 100b via computing device 100c to the different amount of computing resources on one of the virtual machines on servers 100e.

In one or more embodiments, the communication network 100d may comprise one or more wired communication networks, one or more wireless communication networks, or a combination thereof. Further, computing device 100c may comprise a desktop computer, terminal computer, laptop computer, tablet computer, mobile phone, mobile phone, or any other computing device the user 100b may use to conduct a particular task or application utilizing the available computing resources on one or more virtual machines instantiated on servers 100e. Server 100a and each of servers 100e may comprise one or more servers residing in one location or spanning multiple locations, one or more virtual servers residing in one location or spanning multiple locations, one or more cloud servers, or a combination thereof.

Referring to FIG. 1B, in one or more embodiments, method 110 describes aspects of the functions of system 100. Further, aspects of method 110 may be implemented by server 100a. Method 110 may include server 100a, at 110a, determining a user score for user 100b by the user score calculation system 100g implementing a ML software application utilizing a first plurality of ML models. Further, the method 110 may include server 100a, at 110b, receiving a request for computing device 100c, via user-generated input by user 100b. The method 110 may include the server 100a, at 110c, determining an amount of computing resources for user 100b based on the user score as well as other user properties and/or machine properties by the computer resources recommendation system 100f implementing a ML software application utilizing a second plurality of ML models. The method 110 may include the server 100a, at 110d, identifying computing resources associated with a virtual machine instantiated on one or more servers 100e, based on the amount of computing resources, by the virtual machine assignment system 100h. Further, the method 110 may include the server 100a, at 110e, providing access to the virtual machine by the virtual machine assignment system 100h.

In one or more embodiments, method 110 may include server 100a, at 110f, providing a recommendation of computing resources to computing device 100c, which in turn displays it to user 100b. Further, method 110 may include server 100a, at 110g, receiving user-generated input from the computing device 100c indicating accepting the recommended computing resources. Method 110 may include server 100a, at 110e, providing access to user 100b via computing device 100c to the computing resources on one of the virtual machines instantiated on servers 100e. Alternatively, method 110 may include server 100a, at 110h, receiving user-generated input from computing device 100c indicating not accepting the recommended computing resources. The user-generated input may indicate a different amount of computing resources. Further, method 110 may include server 100a, at 110i, identifying different computing resources based on the user-generated input associated with another virtual machine by the virtual machine assignment system 100h. The method 110 may include the server 100a, at 110j, providing access user 100b via computing device 100c to the other virtual machine instantiated on servers 100e.

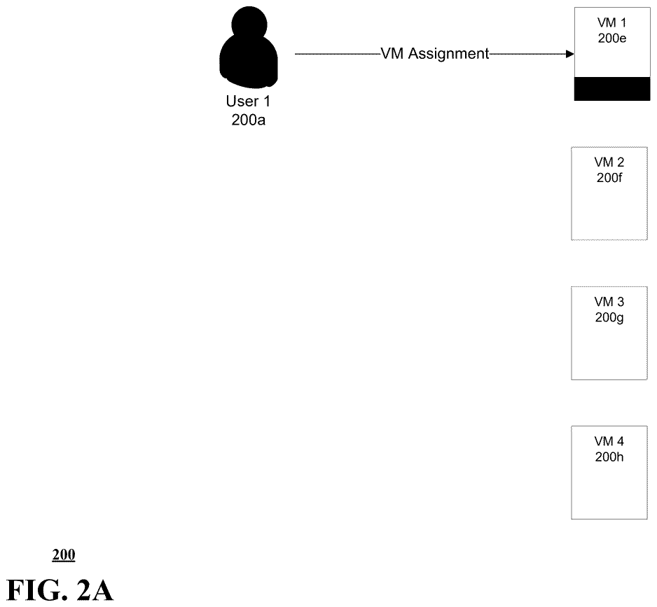

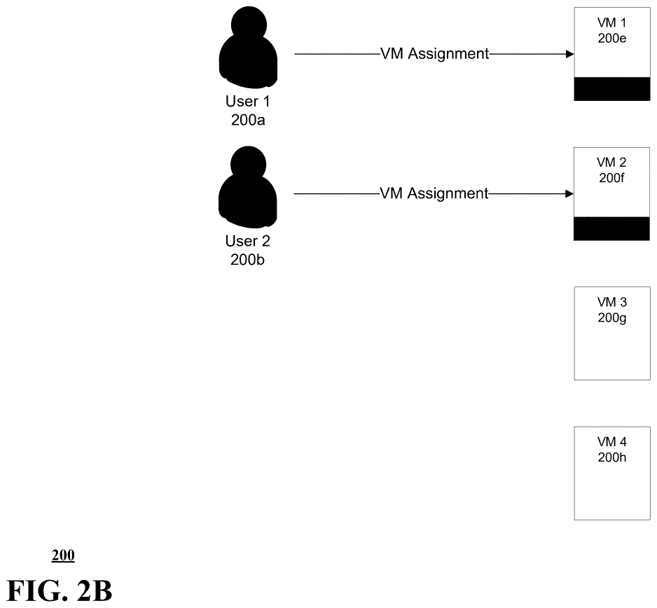

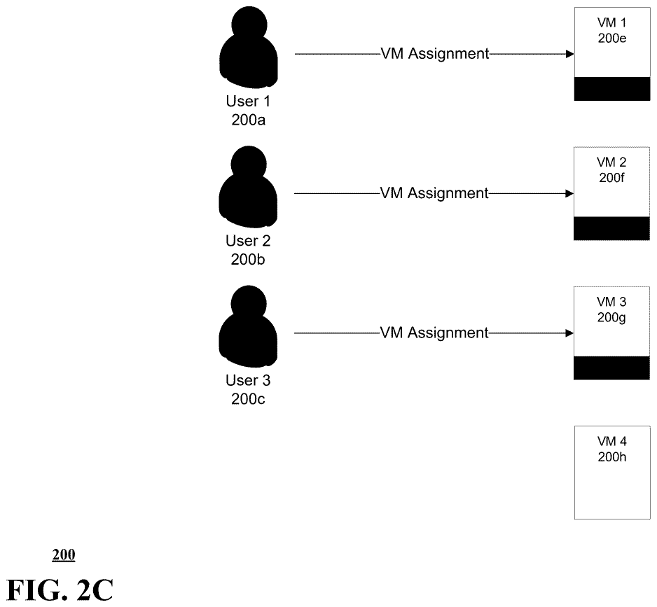

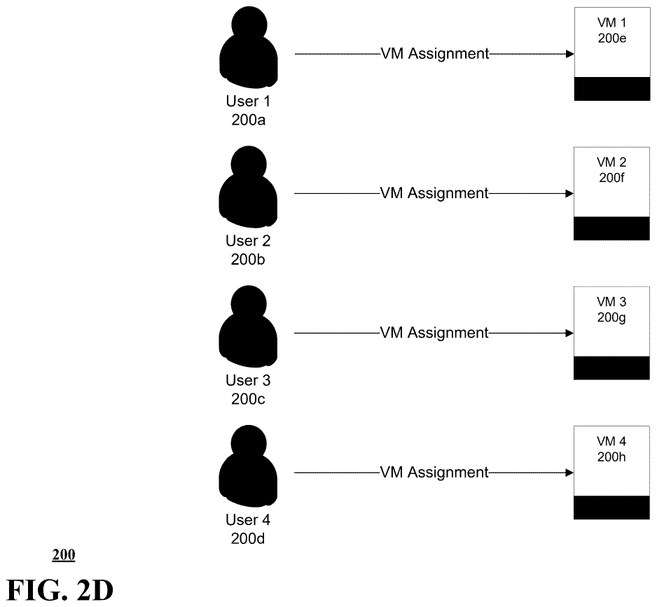

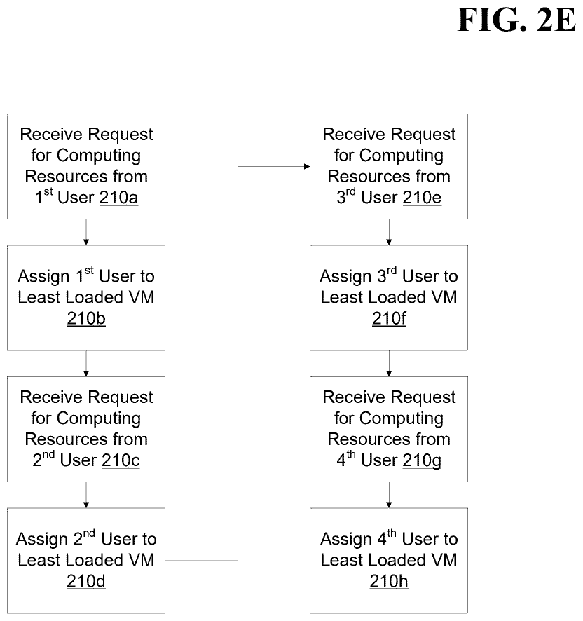

Referring to FIGS. 2A-2D, in one or more embodiments, system 200 may implement an embodiment of the virtual machine assignment system 200h described in FIG. 1. Referring to FIG. 2A, in one or more embodiments, a user 200a may request computing resources for a particular task or application from server 100a. Further, without computing or utilizing any user score associated with the user 200a regarding historical use of computing resources or any application score for a particular task or application, the virtual machine assignment system 100h may assign user 200a to virtual machine 200e because virtual machine 200e has the least load (or equally the least load) among virtual machine 200e, virtual machine 200f, virtual machine 200g, and virtual machine 200h. Referring to FIG. 2B, in one or more embodiments, a user 200b may request computing resources for a particular task or application from server 100a. Without computing or utilizing any user score associated with the user 200b regarding historical use of computing resources or any application score for a particular task or application, the virtual machine assignment system may assign user 200b to virtual machine 200f because virtual machine 200f has the least load (or equally the least load) among virtual machine 200e, virtual machine 200f, virtual machine 200g, and virtual machine 200h. Referring to FIG. 2C, in one or more embodiments, a user 200c may request computing resources for a particular task or application from server 100a. Without computing or utilizing any user score associated with the user 200c regarding historical use of computing resources or any application score for a particular task or application, the virtual machine assignment system 100h may assign user 200c to virtual machine 200g because virtual machine 200g has the least load (or equally the least load) among virtual machine 200e, virtual machine 200f, virtual machine 200g, and virtual machine 200h. Referring to FIG. 2D, in one or more embodiments, a user 200d may request computing resources for a particular task or application from server 100a. Without computing or utilizing any user score associated with the user 200d regarding historical use of computing resources or any application score for a particular task or application, the virtual machine assignment system may assign user 200d to virtual machine 200h because virtual machine 200h has the least load among virtual machine 200e, virtual machine 200f, virtual machine 200g, and virtual machine 200h.

In one or more embodiments, system 100 may have a tier cloud computing services provided to it by a cloud computing provider. For example, the tier cloud computing services may include a high-level tier, a mid-level tier, and/or a low-level tier. The high-level tier may include a plurality of virtual machines each having a high level of computing resources (e.g., processor capacity, memory capacity, etc.). The mid-level tier may include a plurality of virtual machines each having a medium level of computing resources (e.g., processor capacity, memory capacity, etc.). The low-level tier may include a plurality of virtual machines each having a low level of computing resources (e.g., processor capacity, memory capacity, etc.).

In one or more embodiments, without computing or utilizing a user score associated with a user's estimated amount of computing resources, the virtual machine assignment system may assign a user to computing resources to a tier of cloud computing services that does not efficiently or cost-effectively use the computing resources assigned to them. For example, the user may be assigned to a low-level tier or mid-level tier, when the particular task requires computing resources from the high-level tier. Consequently, the user may have a poor user experience in conducting their particular task or application. Alternatively, the user may be assigned to a high-level tier, when the particular task only requires computing resources from the mid-level tier or low-level tier. Consequently, the user may inefficiently use available computing resources thereby incurring unnecessary cost of computing resources while conducting their particular task or application.

In one or more embodiments, the system 100 may improve on the embodiments previously discussed by calculating a user score that is associated with an estimated amount of computing resources by the user score calculation system 100g. The computer resources recommendation system 100h may determine an amount of computer resources for the user based on its user score. Further, the virtual machine assignment system 100h may assign the user to a low-level tier, a mid-level tier, or a high-level tier according to their user score to more efficiently and/or cost-effectively use the computing resources.

Referring to FIG. 2E, in one or more embodiments, aspects of method 210 may be implemented by server 100a to assign users to different virtual machines in system 200 as shown in FIGS. 2A-2D. Further, the method 210 may include server 100a, at 210a, receiving a request for computing resources from user 200a via a computing device. The method 210 may include the server 100a, at 210b, assigning user 200a to virtual machine 200e because virtual machine 200e has the least load among the plurality of virtual machines utilizing the virtual machine assignment system 100h. Further, the method 210 may include server 100a, at 210c, receiving a request for computing resources from user 200b via a computing device. The method 210 may include the server 100a, at 210d, assigning user 200b to virtual machine 200f because virtual machine 200f has the least load among the plurality of virtual machines utilizing the virtual machine assignment system 100h. Further, the method 210 may include server 100a, at 210e, receiving a request for computing resources from user 200c via a computing device. The method 210 may include the server 100a, at 210f, assigning user 200c to virtual machine 200g because virtual machine 200g has the least load among the plurality of virtual machines utilizing the virtual machine assignment system 100h. Further, the method 210 may include server 100a, at 210g, receiving a request for computing resources from user 200d via a computing device. The method 210 may include the server 100a, at 210h, assigning user 200a to virtual machine 200h because virtual machine 200h has the least load among the plurality of virtual machines utilizing the virtual machine assignment system 100h.

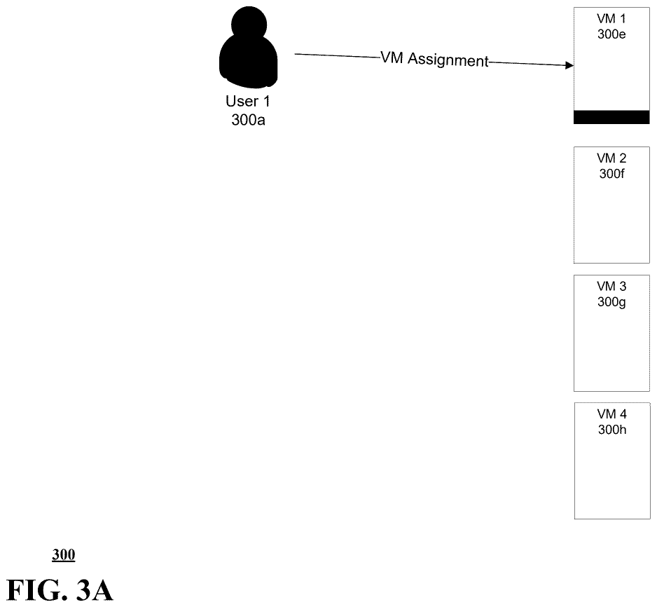

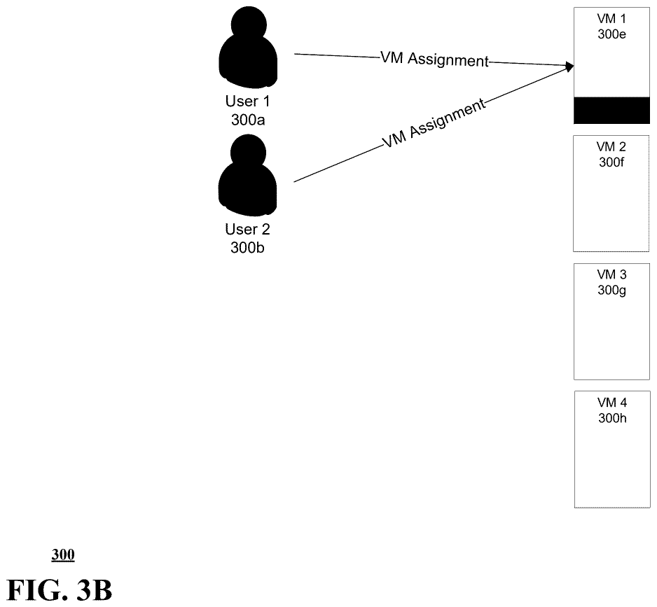

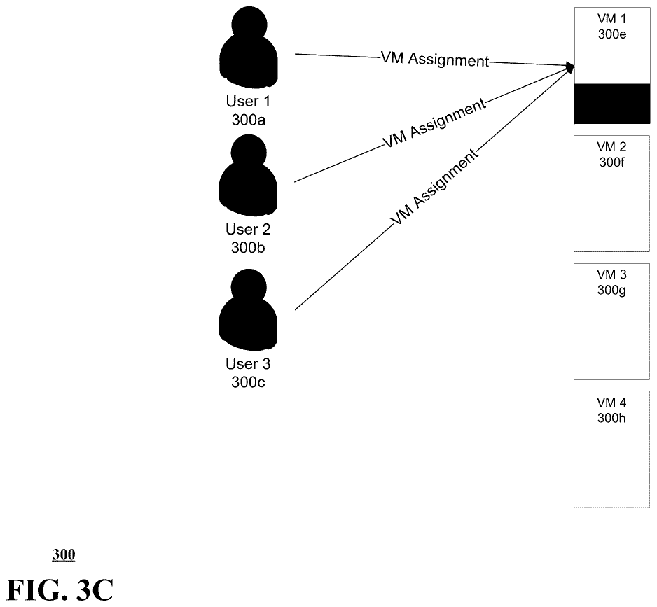

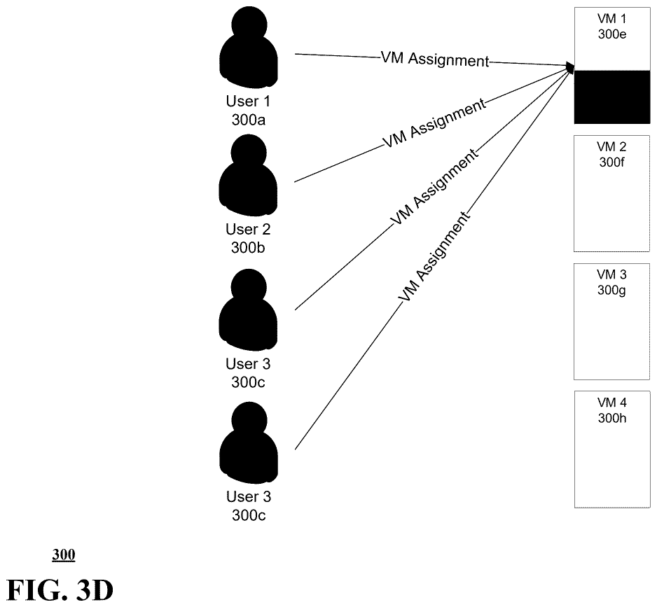

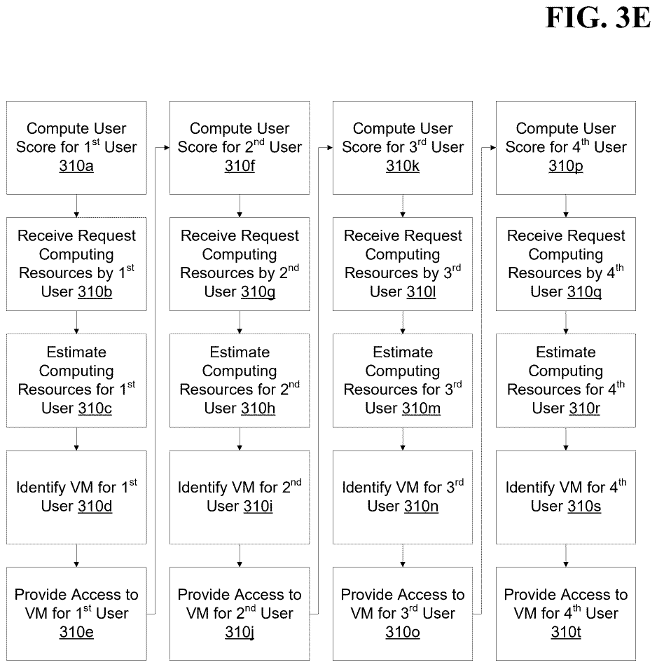

Referring to FIGS. 3A-3D, in one or more embodiments, system 300 may implement embodiments of the user score calculation system 100g, the computing resources recommendation system 100h, and the virtual machine assignment system 100h, as described herein. Referring to FIG. 3A, in one or more embodiments, the user score calculation system 100g may compute a user score associated with user 300a based on machine properties utilizing a first plurality of machine learning models, as described herein. Further, a user 300a may request computing resources for a particular task or application from server 100a. After computing a user score associated with the user 300a, the computing resources recommendation system may estimate the amount of computer resources needed by user 300a based on its user score (and/or other user properties and/or machine properties) utilizing a second plurality of ML models. The virtual machine assignment system 100h may provide user 300a access to virtual machine 300e based on the estimated amount of computer resources. Referring to FIG. 3B, in one or more embodiments, the user score calculation system 100g may compute a user score associated with user 300b based on machine properties utilizing the first plurality of machine learning models, as described herein. Further, a user 300b may request computing resources for a particular task or application from server 100a. After computing a user score associated with the user 300b, the computing resources recommendation system 100f may estimate the amount of computer resources needed by user 300b based on its user score (and/or user properties and/or machine properties) utilizing a second plurality of ML models. The virtual machine assignment system 100h may identify and provides user 300b access to virtual machine 300e rather than any of virtual machine 300f, virtual machine 300g, and virtual machine 300h, even though none of virtual machine 300f, virtual machine 300g, and virtual machine 300h are being currently utilized. This is because the virtual machine assignment system 100h may be programmed to try to fully allocate the computing resources of one virtual machine (e.g., virtual machine 300e) prior to assigning available computing resources from other virtual machines (e.g., virtual machine 300f, virtual machine 300g, and virtual machine 300h) to a user (e.g., user 300b). This may provide more efficient use of computing resources among virtual machine 300e, virtual machine 300f, virtual machine 300g, and virtual machine 300h, thereby incurring less cost for computing resources, as well as providing a sufficient user experience. Referring to FIG. 3C, in one or more embodiments, the user score calculation system 100g may compute a user score associated with user 200c based on machine properties utilizing the first plurality of machine learning models, as described herein. Further a user 300c may request computing resources for a particular task or application from server 100a. After computing a user score associated with the user 300c, the computing resources recommendation system 100f may estimate the amount of computing resources needed by user 300c based on its user score (and/or user properties and/or machine properties) utilizing a second plurality of ML models. The virtual machine assignment system 100h may identify and provide user 300c access to virtual machine 300e rather than any of virtual machine 300f, virtual machine 300g, and virtual machine 300h, even though none of virtual machine 300f, virtual machine 300g, and virtual machine 300h are being currently utilized. This is because the virtual machine assignment system 100h may be programmed to try to fully allocate the computing resources of one virtual machine (e.g., virtual machine 300e) prior to assigning available computing resources from other virtual machines (e.g., virtual machine 300f, virtual machine 300g, and virtual machine 300h) to a user (e.g., user 300c). This may provide more efficient use of computing resources among virtual machine 300e, virtual machine 300f, virtual machine 300g, and virtual machine 300h, thereby incurring less cost for computing resources, as well as providing a sufficient user experience. Referring to FIG. 3D, in one or more embodiments, the user score calculation system 100g may compute a user score associated with user 300d based on machine properties utilizing the first plurality of machine learning models, as described herein. Further a user 300d may request computing resources for a particular task or application from server 100a. After computing a user score associated with the user 300d, the computing resources recommendation system 100f may estimate the amount of computer resources needed by user 300d based on its user score (and/or user properties and/or machine properties) utilizing a second plurality of ML models. The virtual machine assignment system 100h may identify and provides user 300d access to virtual machine 300e rather than any of virtual machine 300f, virtual machine 300g, and virtual machine 300h, even though none of virtual machine 300f, virtual machine 300g, and virtual machine 300h are being currently utilized. This is because the virtual machine assignment system 100h may be programmed to try to fully allocate the computing resources of one virtual machine (e.g., virtual machine 300e) prior to assigning available computing resources from other virtual machines (e.g., virtual machine 300f, virtual machine 300g, and virtual machine 300h) to a user (e.g., user 300d). This may provide more efficient use of computing resources among virtual machine 300e, virtual machine 300f, virtual machine 300g, and virtual machine 300h, thereby incurring less cost for computing resources, as well as providing a sufficient user experience.

In one or more embodiments, the allocation of users conducting particular tasks or applications to virtual machines by the virtual machine assignment system 100h in physical data centers may be referred to as a virtual machine (VM) placement problem. One or more embodiments may provision the infrastructure associated with the virtual machines and/or allocate virtual machines dynamically as users request available computing resources in an optimal or improved manner. That is, the provisioning and/or the allocating may be done to maximize or increase the utilization of the given provisioned infrastructure by the virtual machine assignment system 100h, given the users' requirements as determined by their respective user score calculated by the user score calculation system 100g. The virtual machine assignment system 100h may solve the VM placement problem by assigning a virtual machine to a user. Use of the virtual machine assignment system 100h may reduce inefficiency in utilization of computing resources of the virtual machines and/or may save costs, accordingly, in the long term.

In one or more embodiments, the VM placement problem may be solved by the virtual machine assignment system 100h may be formulated as a min-max optimization problem that may be translated into a linear program implemented by a linear programming software application. For example, such a linear programming software application may solve an optimization problem utilizing robust algorithms, such as from the class of interior-point methods. Due to the scale of the data, further embodiments may adopt heuristics algorithms and/or may determine an approximated or estimated solution.

Referring to FIG. 3E, aspects of method 310 may be implemented by server 100a to assign users to different virtual machines in system 300 as shown in FIGS. 3A-3D. Method 310 may include server 100a, at 310a, computing a user score for user 300a by the user score calculation system 100g based on one or more machine properties utilizing a first plurality of ML models. Further, the method 310 may include server 100a, at 310b, receiving a request for computing resources from user 300a. The method 310 may include server 100a, at 310c, estimating computing resources for user 300a based on their user score (and/or other user properties and/or machine properties) by the computing resources recommendation system 100f utilizing the second plurality of ML models. The method 310 may include server 100a, at 310d, identifying virtual machine 300e based on the estimated of computing resources utilizing the virtual machine assignment system 100h implementing a linear programming software application. The method 310 may include server 100a, at 310e, providing access to virtual machine 300e for user 300a by the virtual machine assignment system 100h.

In one or more embodiments, method 310 may include server 100a, at 310f, computing a user score for user 300b by the user score calculation system 100g based on one or more machine properties utilizing a first plurality of ML models. Further, the method 310 may include server 100a, at 310g receiving a request for computing resources from user 300b. The method 310 may include server 100a, at 310h, estimating computing resources for user 300b based on their user score (e.g., and/or other user properties and/or machine properties) by the computing resources recommendation system 100f utilizing the second plurality of ML models. The method 310 may include server 100a, at 310i, identifying virtual machine 300e based on the estimated of computing resources utilizing the virtual machine assignment system 100h implementing a linear programming software application. The method 310 may include server 100a, at 310j, providing access to virtual machine 300e for user 300b by the virtual machine assignment system 100h.

In one or more embodiments, method 310 may include server 100a, at 310k, computing a user score for user 300c by the user score calculation system 100g based on one or more machine properties utilizing a first plurality of ML models. Further, the method 310 may include server 100a, at 310l receiving a request for computing resources from user 300c. The method 310 may include server 100a, at 310m, estimating computing resources for user 300c based on their user score (and/or other user properties and/or machine properties) by the computing resources recommendation system 100f utilizing the second plurality of ML models. The method 310 may include server 100a, at 310n, identifying virtual machine 300e based on the estimated of computing resources utilizing the virtual machine assignment system 100h implementing a linear programming software application. The method 310 may include server 100a, at 310o, providing access to virtual machine 300e for user 300c by the virtual machine assignment system 100h.

In one or more embodiments, method 310 may include server 100a, at 310p, computing a user score for user 300d by the user score calculation system 100g based on one or more machine properties utilizing a first plurality of ML models. Further, the method 310 may include server 100a, at 310q receiving a request for computing resources from user 300g. The method 310 may include server 100a, at 310r, estimating computing resources for user 300g based on their user score (and/or other user properties and/or machine properties) by the computing resources recommendation system 100f utilizing the second plurality of ML models. The method 310 may include server 100a, at 310s, identifying virtual machine 300e based on the estimated of computing resources utilizing the virtual machine assignment system 100h implementing a linear programming software application. The method 310 may include server 100a, at 310t, providing access to virtual machine 300e for user 300d by the virtual machine assignment system 100h.

In one or more embodiments, the virtual machine assignment system 100h may be programmed to try to fully allocate the computing resources of one virtual machine (e.g., virtual machine 300e) prior to assigning available computing resources from other virtual machines (e.g., virtual machine 300f, virtual machine 300g, and virtual machine 300h) to a user (e.g., user 300b). This may provide more efficient use of computing resources among virtual machine 300e, virtual machine 300f, virtual machine 300g, and virtual machine 300h, thereby incurring less cost for computing resources, as well as providing a sufficient user experience.

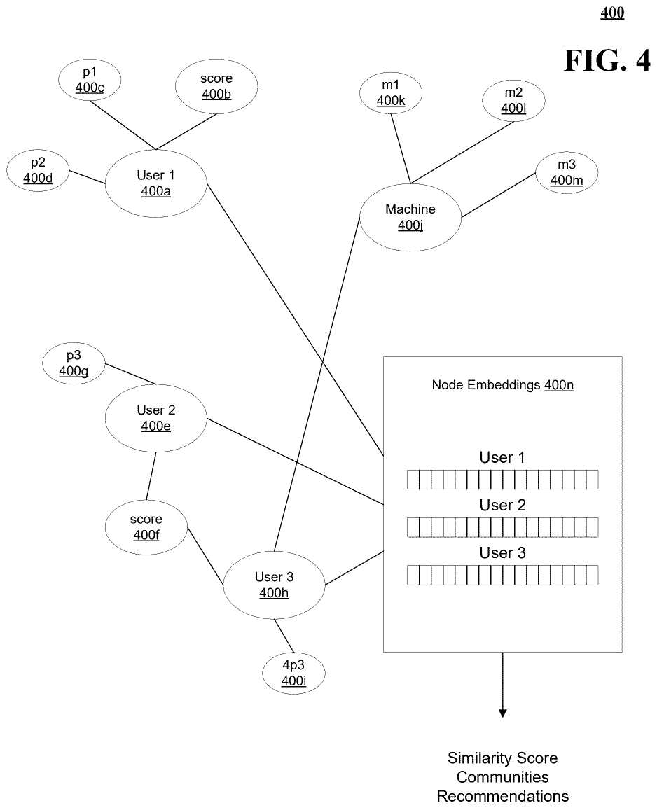

Referring to FIG. 4, in one or more embodiments, properties may be used by the user score calculation system 100g to calculate a user score for a user. This calculation may be performed prior to any recommendation of computing resources or assignment of a user to a virtual machine to access computing resources. To calculate a user score, the user score calculation system 100g may utilize one or more ML models from a plurality of ML models.

Some embodiments may be used to implement an ML model from the plurality of ML models based on the available processing capacity and/or memory capacity available to the user score calculation system 100g. That is, if one of the ML models from the plurality of ML models requires significant processing capacity and/or memory capacity, and such processing capacity and/or memory capacity is available to the user score calculation system 100g, then the user score calculation system 100g may select such an ML model.

Alternatively, if one of the ML models from the plurality of ML models requires significant processing capacity and/or memory capacity, and such processing capacity and/or memory capacity is not available to the user score calculation system 100g, then the user score calculation system 100g may select a machine learning model that requires less processor capacity and/or memory capacity and is less than the available processor capacity and/or memory capacity available to the user score calculation system 100g.

In one or more embodiments, the graph database 400 may include several nodes representing a user, user properties, a user score, a virtual machine, and/or machine properties. Further, the graph database 400 may include a user node 400a that is associated with a user score node 400b, user property node 400c, and/or user property node 400d. The graph database 400 may include a user node 400e associated with a user score 400f and/or user property 400g. The graph database 400 may include a user node 400h associated with user score 400f and/or user property node 400i. User node 400e and user node 400h may share a user score node 400f because they may be on the same team (e.g., same working group on a project, same department in a business entity, etc.) and use the same amount or similar amount of computing resources. Further, the graph database 400 may include a virtual machine node 400j associated with machine property 400k, machine property 400l, and/or machine property 400m. User node 400h may be associated with virtual machine node 400j indicating user 3 is assigned to virtual machine associated with virtual machine node 400j.

In one or more embodiments, each user node may be used by the second plurality of ML models to generate a vector embedding 400n for the user. A vector embedding may be a high dimensional numerical representation of a node's text features, so that they may be processed by ML models. Given a set of users, their properties and/or relationships, the system 400 may determine/compute the communities that may correspond to the virtual machine recommendations, e.g., the plurality of users that would correspond to a specific recommendation. When a new user is added to the graph database 400, it may be possible to compute its similarity score (e.g., a mathematical measure of how close two vector embeddings are, computed as the dot product of the two vectors normalized by a measure of their length, typically their l2-norm) with other users to determine the most advantageous recommendation/assignment of computing resources for them, even when no historical information is available.

In one or more embodiments, the first plurality of ML models may be used to calculate a user forecasted usage, and represent such usage as a user score. First plurality of ML models may use a DeepAR autoregressive ML model. Any ML model, including the DeepAR autoregressive ML model may be pretrained initially on a fixed time period of historical data based on metrics associated with a user, such as the CPU utilization, memory consumption and/or the number of processes running. Temporal periodicity may be encoded with splines basis functions. Classic hyperparameter tuning (e.g., for example on the number of layers, hidden units and/or resampling frequency) may be used to find the most advantageous aspects of the ML model to deploy. ML models are evaluated against standard metrics for time series problems, such as the mean absolute error (MAE) or the root mean squared error (RMSE). The most advantageous ML model may be deployed within a designated cloud server provider, and a first plurality of ML models may continuously train the ML model on newly acquired data on a periodic (e.g., monthly) basis, for example. Further embodiments may include, for example, changing the features of the ML model, and performing ablation studies, upon using standard techniques such as shadow deployment. Once trained, the ML model may be used in inference mode to compute a user's forecast usage on regular time intervals. The unique user score that indicates a user's forecast usage may be derived by averaging the forecast data points with custom weights (e.g., accounting for example for regional and/or user holidays), and it may then be inputted into the graph database. An ML model may be similarly used to calculate an application score, as described herein.

One or more embodiments include a seamless automated vertical autoscaling of instances on virtual machines. Advantages of the embodiments described herein may include allocating a virtual machine to a user that may be used optimally, and it reflects a more accurate need of the user and/or their applications. Thus, one or more embodiments may avoid under-provisioning or overprovisioning of computing resources to a user. Further advantages of the embodiments may include enabling cost saving from the user perspective. Additional advantages of the embodiments may include avoiding expensive downtime due to manual instance rescaling. One or more embodiments may include the instance being rescaled appropriately ahead of time, with no manual intervention required. The advantages of the embodiments may include enabling a more accurate virtual machine recommendation for each user, depending on all user properties and/or requirements, for example, similarity with other users, user score, application score, and/or physical locations. Further advantages of the embodiments may include the virtual machines are seamlessly allocated optimally to a user within the data centers based on the specified constraints, to maximize cost savings and/or user experience, while minimizing environmental footprint. This unlocks cost saving from the cloud provider perspective.

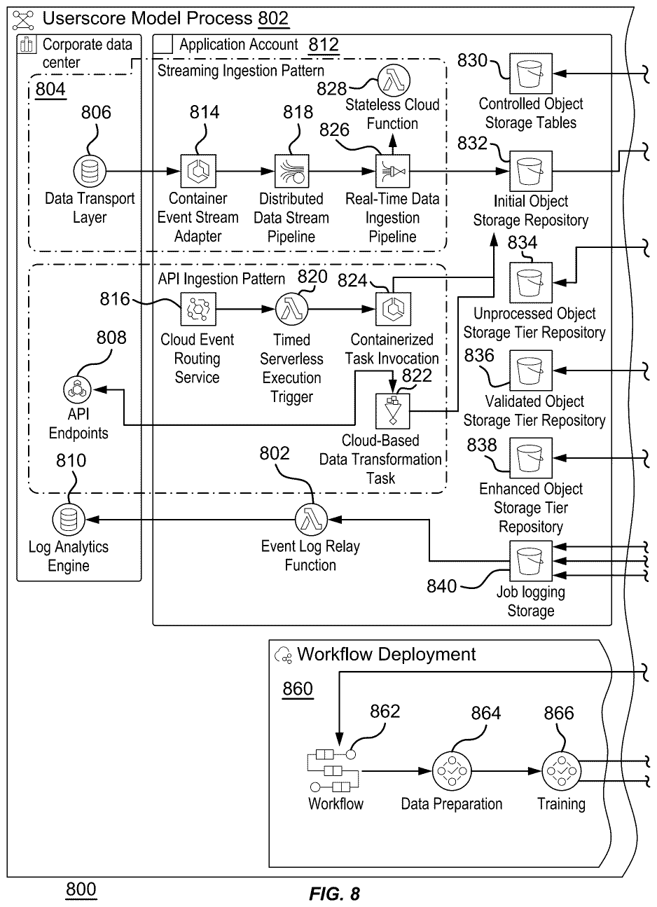

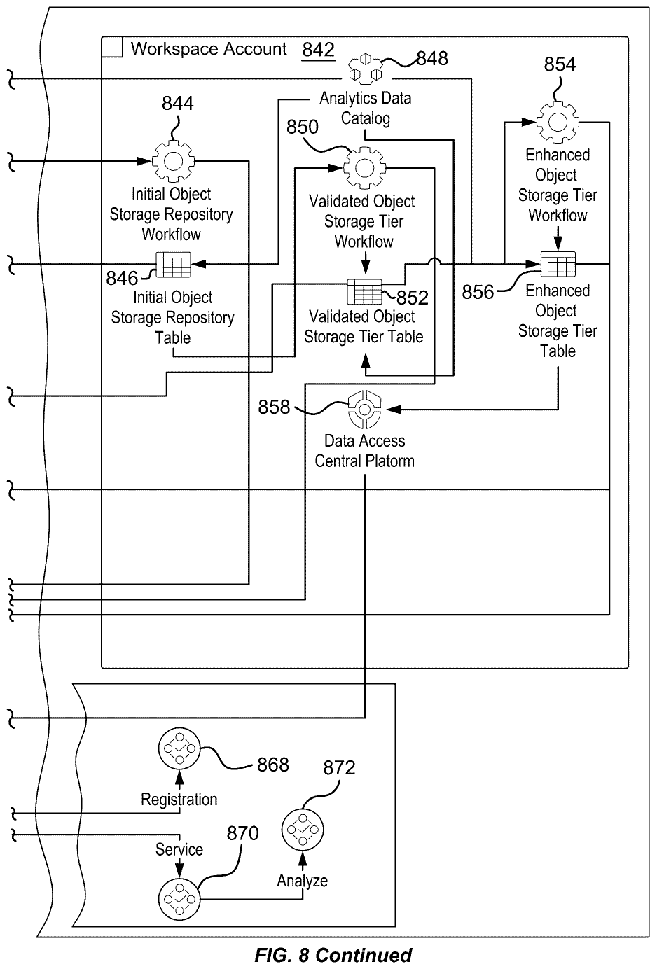

FIG. 8 is a block diagram illustrating an example, non-limiting embodiment of a system 800 functioning in accordance with various aspects described herein. One or more embodiments include a model that produces a user score via the DeepAR architecture described herein. System 800 includes the components involved in the implementation and in the data flow in a production environment. Aspects of system 800 may include or overlap with aspects of system 100.

In one or more embodiments, data may be streamed via distributed data stream pipeline 818, real-time data ingestion pipeline 826, containerized task invocation 814, generalized data transport layer 806 and/or API endpoints 808. Further, data may be stored in dedicated storage repositories, which may be based on types or adjustments to data including raw data, trusted data, and/or adjusted/refined data such as: unprocessed object storage tier 834, validated object storage tier 836, and enhanced object storage tier 840. The system 800 may use various components and/or techniques for processing and/or transforming and/or adjusting including cloud-based data transformation task 822, analytics workflow distribution process 860 (e.g., validated object storage tier workflow 850, enhanced object storage tier workflow 854) and/or controlled object storage tables 830 in the analytics data catalog 848 for processing and/or transformation. The system 800 may use cloud-based data transformation task 822, analytics workflow distribution process 860 (e.g., validated object storage tier workflow 850, enhanced object storage tier workflow 854) and/or controlled object storage tables 830 in or otherwise associated with the analytics data catalog 848. For example, cloud-based data transformation task 822 may ingest and prepare raw cloud data, analytics workflow distribution process 860 may orchestrate scalable transformations from raw to trusted to refined datasets, and controlled object storage tables 860 may provide a governed, secure storage layer for these processed datasets, together forming a cloud-based data pipeline that may support and/or feed AI and/or ML models. In some embodiments, orchestration may be executed via stateless cloud functions 828, cloud event routing service 816 for scheduling and containerized task invocation 824. Further, the system 800 may abide by governance by creating or otherwise obtaining data access control platform polices 858 for data access control. The system model pipeline of system 800 may follow a particular (e.g., predetermined, dynamic, standardized, etc.) lifecycle when deploying a analytics workflow distribution process 862 such as: data preparation 864, training 866, registration 868, serving 870, and/or analysis 872 (e.g., may include registration 868, to abide by the firm's policy requirements).

In one or more embodiments, the model may be trained during a training phase. In order to have accurate predictions of the memory and/or the CPU consumption, the system may split the models that are being trained and define two (or more) separate models. Each model may be fine-tuned and pushed to production separately. Further, the model(s) trained on the memory consumption may require additional features, as the CPU consumption (e.g., in milliseconds) and/or the maximum number of processes running, while for the model trained for the CPU consumption it suffices to use the historical values of the CPU consumption alone. That is, these separate models may differ in terms of input features; in particular, the features that were used for the memory and/or CPU models separately. The input features for the two models may be different. For both models, in order to achieve maximally conservative estimates of the CPU and/or memory consumptions, some embodiments may use the maximum of the CPU and/or memory when performing the resampling, while other embodiments may use a median or an average of the CPU and/or memory. In some embodiments, this may introduce some noise in the data. From a performance and/or capacity perspective, utilizing the maximum as a metric resampling strategy in one or more embodiments may be an improvement, particularly from a business perspective. To speed up the search over the hyperparameter space, the system may leverage HR attributes to split or otherwise separate the training dataset into smaller and/or more manageable subsets. Hyperparameter tuning may be carried out as described herein (e.g., searching over the number of layers, hidden units, learning rate, gradient clipping and/or dropout), and the corresponding resulting models may be pushed to production, accordingly.

In one or more embodiments, the system may leverage a streaming graph interpreter as an instantiation of the graph database described herein. Further, the system may, for example, continuously stream the relevant data feeds (e.g., all the relevant data feeds) into the graph, to achieve a digital twin (e.g., an identical digital copy and/or imitates, at least functionally, the infrastructure and/or user interactions) of the infrastructure and/or users. As a result, this implementation may provide more use cases than the ones than otherwise envisioned by operator personnel. As an example, the system may perform real-time monitoring of the infrastructure. That is, real-time monitoring may be achieved via standing queries (e.g., queries written in the Cypher language that may be programmed to be executed, for example, continuously on the graph), and/or the implementation of anomaly detection algorithms. As described herein, one or more embodiments may include a deterministic recommendation system based on the user score value that may assign a (e.g., each) user to a virtual machine with available computing resources for the user to complete a task or implement an application, accordingly.

In one or more embodiments, the algorithm may include, but is not limited to, a number of functions. The functions of the algorithm include (e.g., which may be implemented in no particular order), at 1, the algorithm may compute a machine type value as a linear combination of the number of CPU cores and/or memory capacity of the machine. The computation is enabled efficiently due to the connections are exposed through the graph. At 2, the algorithm may assign a machine type value to all the physical machines in the infrastructure, for a (e.g., each) delivery group, site and/or datacenter. At 3, the value of the user score, may allow the algorithm to determine whether the user needs an upgrade/downgrade of the machine. At 4, if any of the two operations are needed, the algorithm may match the user with the list of compatible delivery groups, according to the user score and/or the machine type value. At 5, the algorithm may select one of the compatible delivery groups and the algorithm may assign the user to the selected one or more delivery groups.

In one or more embodiments, as described herein, the system may distribute the virtual machines allocated to the clusters in an optimal or efficient manner. In some embodiments, the system may expect multiple sequential virtual machines requests, as they are created and allocated, and possibly deleted. The optimization of the entire datacenter estate at once may result in an unmanageable problem, even if the system considers a single datacenter at a time. In other embodiments, the system may implement a strategy that is solving the localized optimization problem and that in the long run is expected to produce an optimal environment. To do so, the system may implement a query that verifies continuously whether certain clusters have been overprovisioned, for example, they have been allocated too many virtual machines (e.g., they have been given too many computing resources) and therefore their CPU, memory or disk utilization is above a specific numerical threshold. Different thresholds may be specified for one or more (e.g., each) of the metrics, depending on business requirements. The system may refer to these clusters as hot clusters. Once these hot clusters have been identified, the system may use a trigger that may execute several functions. The system functions may include (in no particular order), at 1 the system may collect relevant metric data for the cluster that is running hot, and/or of the other clusters available within the same vCenter and/or datacenter (e.g., virtual machines cannot move across these physical barriers, determined by the vCenter and/or datacenter). At 2, the system may collect metric data for the virtual machines that have been targeted to move (they may be simply the last ones that have been allocated to the cluster, or the ones that have been least moved within the environment). At 3, the system may solve the Chebyshev approximation problem as a linear program and identify the new clusters where the targeted virtual machines should be moved. The objective function may be to minimize the number of clusters running at any one point in time within the vCenter. The trigger may be required to use the any (e.g., Java) programing language and therefore the system may use the OR-Tools optimization library with a default solver. At 4, the system may send the clusters names to an orchestration engine that may take action on the environment. In one or more embodiments, the system has no need to pass the information back to the graph, as the changes may manifest themselves within the new data ingest. The strategy of avoiding passing information back to the graph enables the system to better distribute and/or allocate the virtual machines within datacenters, at the same time avoiding a big data problem. In some embodiments, a technological improvement for allocating computing resources to a user includes reducing the execution time for the allocation. In other embodiments, execution time may be expected to be low (e.g., in the order of a few seconds) due to the number of variables involved in the optimization of the allocation of computing resources. A low execution time (e.g., on the order of a few seconds) may be considered a technological improvement compared to traditional methods and may be achieved because of the number of variables in optimizing the allocation of the computing resources being limited.

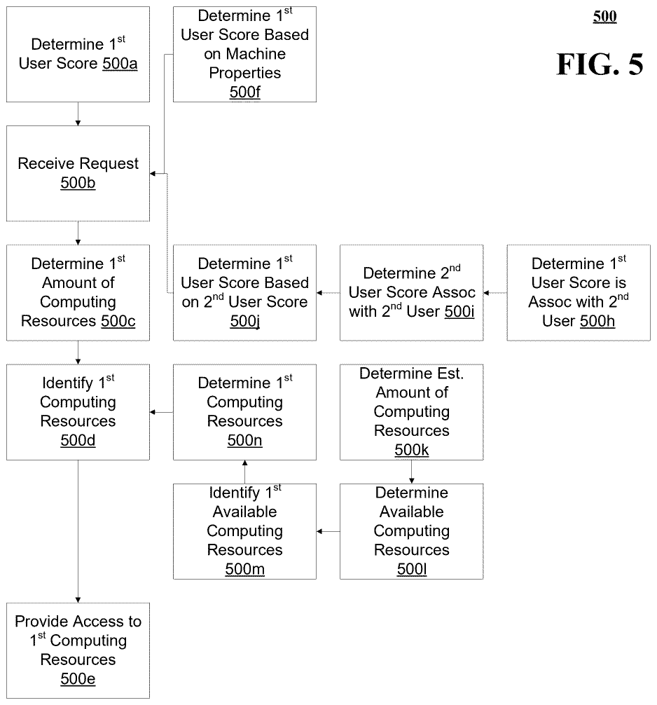

FIG. 5 depicts an illustrative embodiment of a method 500 in accordance with various aspects described herein. Aspects of the method may be implemented by a server (e.g., server 100a) or by other components and/or techniques including virtual network functions. Further, aspects of method 500 may be implemented by a user score calculation system, computer resources recommendation system, and a virtual machine assignment system, described herein. The method 500 may include the server, at 500a, determining a first user score associated with the first user utilizing a machine learning software application implementing a first plurality of ML models. Further, the method 500 may include the server, at 500b, receiving a request for an amount of computing resources from a computing device associated with a first user. The method 500 may include the server, at 500c, determining the amount of computing resources based on a plurality of properties including the first user score accessed from a graph database utilizing a second plurality of ML models. The method 500 may include the server, at 500d, identifying first computing resources associated with a first virtual machine based on the amount of computing resources utilizing a linear programming software application. The method 500 may include the server, at 500e, providing access to the first computing resources to the first user via the computing device.

In one or more embodiments, the machine learning software application utilizes at least one of a plurality of machine learning models. The plurality of machine learning models may comprise a DeepAR autoregressive model, LSTM mode, TFT mode, Nbeats model, and/or NHiTS model. The linear programming software application implements at least one of a plurality of linear programming models. The plurality of linear programming models may comprise a min-max optimization model. The first computing resources may comprise computer processing capacity and/or memory capacity.

In one or more embodiments, the method 500 may include the server, at 500f, determining the first user score based on a plurality of machine properties (e.g., computer processing capacity, memory capacity). Further, the determining of the first user score comprises determining the first user score based on a plurality of machine properties.

In one or more embodiments, the method 500 may include the server, at 500h, determining that the first user score is associated with a second user (e.g., a team member). Further, the method 500 may include the server, at 500i, determining a second user score associated with the second user. The method 500 may include the server, at 500j, determining the first user score based on the second user score. The determination may occur when the first user is a new user, and the second user is a team member of the first user and may have a similar job function such that the first user and the second user may need a similar amount of computing resources. In some embodiments, the determining of the first user score comprises determining that the first user score is associated with a second user, determining a second user score associated with the second user, and determining the first user score based on the second user score. In some embodiments, determining computer resources for a new user may be based on their attributes in the graph database because a new user would not have a user score (e.g., a user score would not yet have been calculated for them).

In one or more embodiments, the method 500 may include the server, at 500k, determining an estimated amount of computing resources based on the first user score and/or other properties (e.g., user properties, machine properties, etc.). Further, the method 500 may include the server, at 500l, determining available computing resources in a (e.g., each of) plurality of virtual machines resulting in a plurality of available computing resources. The method 500 may include the server, at 500m, identifying first available computing resources associated with the first virtual machine is more than the estimated amount of computing resources. The plurality of available computing resources comprises the first available computing resources. The plurality of virtual machines comprises the first virtual machine. The method 500 may include the server, at 500n, determining the first computing resources associated with the first virtual machine based on the first available computing resources and/or the estimated amount of computing resources. The plurality of virtual machines may be implemented by a plurality of servers. The plurality of servers may comprise a plurality of cloud servers.

While for purposes of simplicity of explanation, the respective processes are shown and described as a series of blocks in FIG. 5, it should be understood and appreciated that the claimed subject matter is not limited by the order of the blocks, as some blocks may occur in different orders and/or concurrently with other blocks from what is depicted and described herein. Not all illustrated blocks may be required to implement the methods described herein. Note, one or more blocks may be performed in response to one or more other blocks.

Further, some portions of embodiments may be combined with portions of other embodiments.

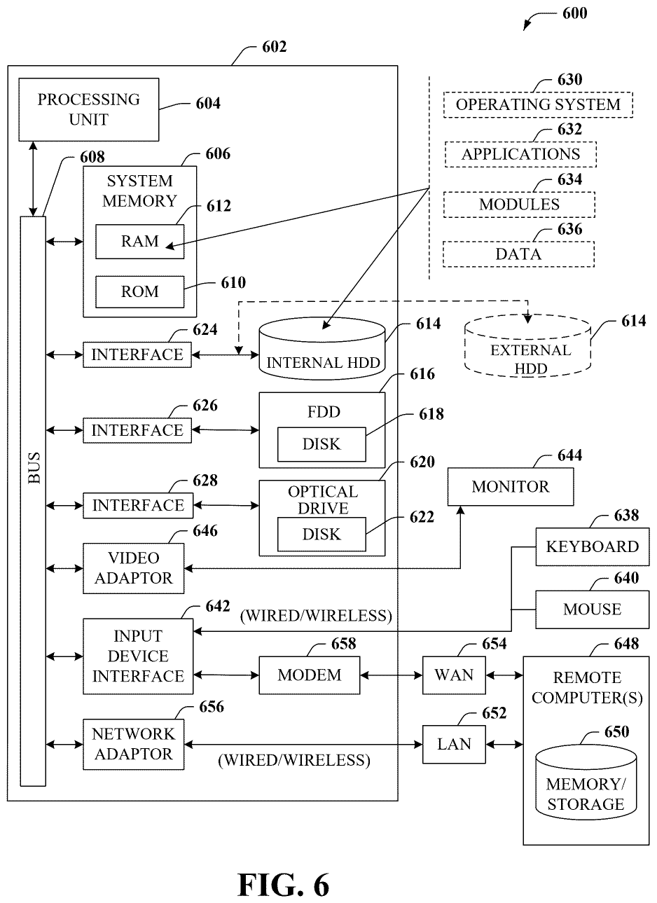

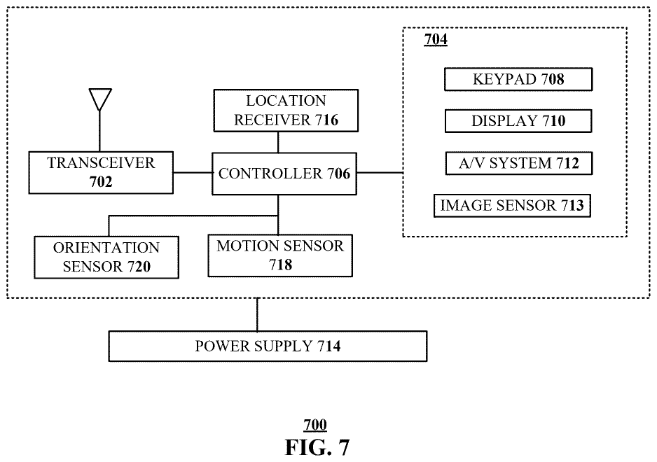

Turning now to FIG. 6, there is illustrated a block diagram of a computing environment in accordance with various aspects described herein. In order to provide additional context for various embodiments of the embodiments described herein, FIG. 6 and the following discussion are intended to provide a brief, general description of a suitable computing environment 600 in which the various embodiments of the subject disclosure may be implemented. In particular, the computing environment 600 may be used in computing device described herein. One or more of the computing devices may be implemented via computer-executable instructions that may run on one or more computers, and/or in combination with other program modules and/or as a combination of hardware and/or software. For example, computing environment 600 may facilitate in whole or in part determining computing resources for a user to conduct a particular task or application based on a user score. One or more of computing device 100c, server 100a, and/or servers 100e may comprise aspects of computing environment 600.

Generally, program modules comprise routines, programs, components, data structures, etc., that perform particular tasks or implement particular abstract data types. Those skilled in the art should appreciate that the methods may be practiced with other computer system configurations, comprising single-processor or multiprocessor computer systems, minicomputers, mainframe computers, as well as personal computers, hand-held computing devices, microprocessor-based or programmable consumer electronics, and/or the like, one or more (e.g., each) of which may be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and/or features described herein in association with the operation of a processor could likewise be performed by a processing circuit.

The illustrated embodiments of the embodiments herein may be practiced in distributed computing environments where certain tasks are performed by remote processing devices that are linked through a communications network. In a distributed computing environment, program modules may be located in local and/or remote memory storage devices.

Computing devices typically comprise a variety of media, which may comprise computer-readable storage media and/or communications media, which two terms are used herein differently from one another as follows. Computer-readable storage media may be any available storage media that may be accessed by the computer and comprises volatile and/or nonvolatile media, removable and/or non-removable media. By way of example, and not limitation, computer-readable storage media may be implemented in connection with any method or technology for storage of information such as computer-readable instructions, program modules, structured data or unstructured data.

Computer-readable storage media may comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which may be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media may be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and/or wireless media such as acoustic, RF, infrared and/or other wireless media.

With reference again to FIG. 6, the example environment may comprise a computer 602, the computer 602 comprising a processing unit 604, a system memory 606 and a system bus 608. The system bus 608 couples system components including, but not limited to, the system memory 606 to the processing unit 604. The processing unit 604 may be any of various commercially available processors. Dual microprocessors and/or other multiprocessor architectures may be employed as the processing unit 604.

The system bus 608 may be any of several types of bus structure that may further interconnect to a memory bus (e.g., with or without a memory controller), a peripheral bus, and a local bus using any of a variety of commercially available bus architectures. The system memory 606 comprises ROM 610 and/or RAM 612. A basic input/output system (BIOS) may be stored in a non-volatile memory such as ROM, erasable programmable read only memory (EPROM), EEPROM, which BIOS contains the basic routines that help to transfer information between elements within the computer 602, such as during startup. The RAM 612 may comprise a high-speed RAM such as static RAM for caching data.

The computer 602 further comprises an internal hard disk drive (HDD) 614 (e.g., EIDE, SATA), which internal HDD 614 may be configured for external use in a suitable chassis (not shown), a magnetic floppy disk drive (FDD) 616, (e.g., to read from or write to a removable diskette 618) and/or an optical disk drive 620, (e.g., reading a CD-ROM disk 622 or, to read from or write to other high-capacity optical media such as the DVD). The HDD 614, magnetic FDD 616 and/or optical disk drive 620 may be connected to the system bus 608 by a hard disk drive interface 624, a magnetic disk drive interface 626 and an optical drive interface 628, respectively. The hard disk drive interface 624 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and/or their associated computer-readable storage media provide nonvolatile storage of data, data structures, computer-executable instructions, and so forth. For the computer 602, the drives and/or storage media accommodate the storage of any data in a suitable digital format. Although the description of computer-readable storage media above refers to a hard disk drive (HDD), a removable magnetic diskette, and/or a removable optical media such as a CD or DVD, it should be appreciated by those skilled in the art that other types of storage media which are readable by a computer, such as zip drives, magnetic cassettes, flash memory cards, cartridges, and/or the like, may be used in the example operating environment, and further, that any such storage media may contain computer-executable instructions for performing the methods described herein.

A number of program modules may be stored in the drives and/or RAM 612, comprising an operating system 630, one or more application programs 632, other program modules 634 and/or program data 636. All or portions of the operating system, applications, modules, and/or data may be cached in the RAM 612. The systems and/or methods described herein may be implemented utilizing various commercially available operating systems or combinations of operating systems.

A user may enter commands and/or information into the computer 602 through one or more wired and/or wireless input devices, e.g., a keyboard 638 and/or a pointing device, such as a mouse 640. Other input devices (not shown) may comprise a microphone, an infrared (IR) remote control, a joystick, a game pad, a stylus pen, touch screen or the like. These and/or other input devices are often connected to the processing unit 604 through an input device interface 642 that may be coupled to the system bus 608, but may be connected by other interfaces, such as a parallel port, an IEEE 1394 serial port, a game port, a universal serial bus (USB) port, an IR interface, etc.

A monitor 644 or other type of display device may be connected to the system bus 608 via an interface, such as a video adapter 646. It should be appreciated that in alternative embodiments, a monitor 644 may be any display device (e.g., another computer having a display, a smart phone, a tablet computer, etc.) for receiving display information associated with computer 602 via any communication means, including via the Internet and/or cloud-based networks. In addition to the monitor 644, a computer typically comprises other peripheral output devices (not shown), such as speakers, printers, etc.

The computer 602 may operate in a networked environment using logical connections via wired and/or wireless communications to one or more remote computers, such as a remote computer(s) 648. The remote computer(s) 648 may be a workstation, a server computer, a router, a personal computer, portable computer, microprocessor-based entertainment appliance, a peer device or other common network node, and typically comprises many or all of the elements described relative to the computer 602, although, for purposes of brevity, only a remote memory and/or storage device 650 is illustrated. The logical connections depicted comprise wired and/or wireless connectivity to a local area network (LAN) 652 and/or larger networks, e.g., a wide area network (WAN) 654. Such LAN and/or WAN networking environments are commonplace in offices and companies, and facilitate enterprise-wide computer networks, such as intranets, all of which may connect to a global communications network, e.g., the Internet.

When used in a LAN networking environment, the computer 602 may be connected to the LAN 652 through a wired and/or wireless communication network interface or adapter 656. The adapter 656 may facilitate wired or wireless communication to the LAN 652, which may comprise a wireless AP disposed thereon for communicating with the adapter 656.

When used in a WAN networking environment, the computer 602 may comprise a modem 658 or may be connected to a communications server on the WAN 654 or has other means for establishing communications over the WAN 654, such as by way of the Internet. The modem 658, which may be internal or external and a wired or wireless device, may be connected to the system bus 608 via the input device interface 642. In a networked environment, program modules depicted relative to the computer 602 or portions thereof, may be stored in the remote memory and/or storage device 650. It should be appreciated that the network connections shown are example and other means of establishing a communications link between the computers may be used.

The computer 602 may be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and/or telephone. The communication may utilize Wireless Fidelity (Wi-Fi) and/or BLUETOOTH® wireless technologies. Thus, the communication may be a predefined structure as with a conventional network or simply an ad hoc communication between at least two devices.

Wi-Fi may allow connection to the Internet from a couch at home, a bed in a hotel room or a conference room at work, without wires. Wi-Fi is a wireless technology similar to that used in a cell phone that enables such devices, e.g., computers, to send and receive data indoors and/or out; anywhere within the range of a base station. Wi-Fi networks use radio technologies called IEEE 802.11 (e.g., a, b, g, n, ac, ag, etc.) to provide secure, reliable, fast wireless connectivity. A Wi-Fi network may be used to connect computers to each other, to the Internet, and/or to wired networks (e.g., which may use IEEE 802.3 or Ethernet). Wi-Fi networks operate in the unlicensed 2.4 and/or 5 GHz radio bands for example or with products that contain both bands (e.g., dual band), so the networks may provide real-world performance similar to the basic 10BaseT wired Ethernet networks used in many offices.

Turning now to FIG. 7, an illustrative embodiment of a communication device 700 is shown. Communication device 700 may facilitate in whole or in part determining computing resources for a user to conduct a particular task or application based on a user score. One or more (e.g., each) of computing device 100c, server 100a, and/or servers 100e may comprise aspects of communication device 700.

The communication device 700 may comprise a wireline and/or wireless transceiver 702 (herein transceiver 702), a user interface (UI) 704, a power supply 714, a location receiver 716, a motion sensor 718, an orientation sensor 720, and/or a controller 706 for managing operations thereof. The transceiver 702 may support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies may include, for example, CDMA-1X, UMTS and/or HSDPA, GSM and/or GPRS, TDMA and/or EDGE, EV and/or DO, WiMAX, SDR, LTE, as well as other next generation wireless communication technologies as they arise. The transceiver 702 may be adapted to support circuit-switched wireline access technologies (e.g., such as PSTN), packet-switched wireline access technologies (e.g., such as TCP/IP, VoIP, etc.), and/or combinations thereof.

The UI 704 may include a depressible or touch-sensitive keypad 708 with a navigation mechanism such as a roller ball, a joystick, a mouse, or a navigation disk for manipulating operations of the communication device 700. The keypad 708 may be an integral part of a housing assembly of the communication device 700 or an independent device operably coupled thereto by a tethered wireline interface (e.g., such as a USB cable) or a wireless interface supporting for example Bluetooth®. The keypad 708 may represent a numeric keypad commonly used by phones, and/or a QWERTY keypad with alphanumeric keys. The UI 704 may further include a display 710 such as monochrome or color LCD (Liquid Crystal Display), OLED (Organic Light Emitting Diode) or other suitable display technology for conveying images to an end user of the communication device 700. In an embodiment where the display 710 is touch-sensitive, a portion or all of the keypad 708 may be presented by way of the display 710 with navigation features.

The display 710 may use touch screen technology to serve as a user interface for detecting user input. As a touch screen display, the communication device 700 may be adapted to present a user interface having graphical user interface (GUI) elements that may be selected by a user with a touch of a finger. The display 710 may be equipped with capacitive, resistive or other forms of sensing technology to detect how much surface area of a user's finger has been placed on a portion of the touch screen display. The sensing information may be used to control the manipulation of the GUI elements or other functions of the user interface. The display 710 may be an integral part of the housing assembly of the communication device 700 or an independent device communicatively coupled thereto by a tethered wireline interface (e.g., such as a cable) or a wireless interface.

The UI 704 may include an audio system 712 that utilizes audio technology for conveying low volume audio (e.g., such as audio heard in proximity of a human ear) and high-volume audio (e.g., such as speakerphone for hands free operation). The audio system 712 may further include a microphone for receiving audible signals of an end user. The audio system 712 may be used for voice recognition applications. The UI 704 may further include an image sensor 713 such as a charged coupled device (CCD) camera for capturing still or moving images.

The power supply 714 may utilize common power management technologies such as replaceable and/or rechargeable batteries, supply regulation technologies, and/or charging system technologies for supplying energy to the components of the communication device 700 to facilitate long-range or short-range portable communications. Alternatively, or in combination, the charging system may utilize external power sources such as DC power supplied over a physical interface such as a USB port or other suitable tethering technologies.

The location receiver 716 may utilize location technology such as a global positioning system (GPS) receiver capable of assisted GPS for identifying a location of the communication device 700 based on signals generated by a constellation of GPS satellites, which may be used for facilitating location services such as navigation. The motion sensor 718 may utilize motion sensing technology such as an accelerometer, a gyroscope, or other suitable motion sensing technology to detect motion of the communication device 700 in three-dimensional space. The orientation sensor 720 may utilize orientation sensing technology such as a magnetometer to detect the orientation of the communication device 700 (e.g., north, south, west, and east, as well as combined orientations in degrees, minutes, or other suitable orientation metrics).

The communication device 700 may use the transceiver 702 to determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 706 may utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and/or processing data supplied by the aforementioned components of the communication device 700.

Other components not shown in FIG. 7 may be used in one or more embodiments of the subject disclosure. For instance, the communication device 700 may include a slot for adding or removing an identity module such as a Subscriber Identity Module (SIM) card or Universal Integrated Circuit Card (UICC). SIM or UICC cards may be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It should be appreciated that the memory components described herein may be volatile memory or nonvolatile memory, or may comprise both volatile and nonvolatile memory, by way of illustration, and not limitation, volatile memory, non-volatile memory, disk storage, and memory storage. Further, nonvolatile memory may be included in read only memory (ROM), programmable ROM (PROM), electrically programmable ROM (EPROM), electrically erasable ROM (EEPROM), or flash memory. Volatile memory may comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and/or direct Rambus RAM (DRRAM). Additionally, the disclosed memory components of systems or methods herein are intended to comprise, without being limited to comprising, these and/or any other suitable types of memory.

It should be noted that the disclosed subject matter may be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and/or the like. The illustrated aspects may be practiced in distributed computing environments where tasks are performed by remote processing devices that are linked through a communications network; however, some if not all aspects of the subject disclosure may be practiced on stand-alone computers. In a distributed computing environment, program modules may be located in local and/or remote memory storage devices.

In one or more embodiments, information regarding use of services may be generated including services being accessed, media consumption history, user preferences, and so forth. The information may be obtained by various methods including user input, detecting types of communications (e.g., video content vs. audio content), analysis of content streams, sampling, and so forth. The generating, obtaining and/or monitoring of the information may be responsive to an authorization provided by the user. In one or more embodiments, an analysis of data may be subject to authorization from user(s) associated with the data, such as an opt-in, an opt-out, acknowledgement requirements, notifications, selective authorization based on types of data, and so forth.

Some of the embodiments described herein may employ artificial intelligence (AI) to facilitate automating one or more features described herein. The embodiments (e.g., in connection with automatically identifying acquired cell sites that provide a maximum value and/or benefit after addition to an existing communication network) may employ various AI-based schemes for carrying out various embodiments thereof. The classifier may be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification may employ a probabilistic and/or statistical-based analysis (e.g., factoring into the analysis utilities and/or costs) to determine or infer an action that a user desires to be automatically performed. A support vector machine (SVM) is an example of a classifier that may be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and/or undirected model classification approaches comprise, e.g., naïve Bayes, Bayesian networks, decision trees, neural networks, fuzzy logic models, and probabilistic classification models providing different patterns of independence maybe employed. Classification as used herein is inclusive of statistical regression that is utilized to develop models of priority.

As should be readily appreciated by one of ordinary skill in the art, one or more of the embodiments may employ classifiers that are explicitly trained (e.g., via a generic training data) as well as implicitly trained (e.g., via observing wireless transmit/receive unit (WRTU) behavior, operator preferences, historical information, receiving extrinsic information). For example, SVMs may be configured via a learning or training phase within a classifier constructor and/or feature selection module. Thus, the classifier(s) may be used to automatically learn and perform a number of functions, including but not limited to determining according to predetermined criteria which of the acquired cell sites should benefit a maximum number of subscribers and/or which of the acquired cell sites should add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity may be hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server may be a component. One or more components may reside within a process and/or thread of execution and a component may be localized on one computer and/or distributed between two or more computers. These components may execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component may be an apparatus with specific functionality provided by mechanical parts operated by electric or electronic circuitry, which is operated by a software or firmware application executed by a processor, wherein the processor may be internal or external to the apparatus and executes at least a part of the software or firmware application. As yet another example, a component may be an apparatus that provides specific functionality through electronic components without mechanical parts, the electronic components may comprise a processor therein to execute software or firmware that confers at least in part the functionality of the electronic components. While various components have been illustrated as separate components, it should be appreciated by one of ordinary skill in the art that multiple components may be implemented as a single component, or a single component may be implemented as multiple components, without departing from example embodiments.

Further, the various embodiments may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage and/or communications media. For example, computer readable storage media may include, but are not limited to, magnetic storage devices (e.g., hard disk, floppy disk, magnetic strips), optical disks (e.g., compact disk (CD), digital versatile disk (DVD)), smart cards, and/or flash memory devices (e.g., card, stick, key drive). Of course, one of ordinary skill in the art should recognize many modifications may be made to this configuration without departing from the scope or spirit of the various embodiments.

The words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. The articles “a” and “an” as used in this application and the appended claims should generally be construed to mean “one or more” unless specified otherwise or clear from context to be directed to a singular form.

Terms such as “WRTU,” “mobile station,” “mobile,” “subscriber station,” “access terminal,” “terminal,” “handset,” “mobile device” (and/or terms representing similar terminology) may refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms may refer to human entities or automated components supported through artificial intelligence (e.g., a capacity to make inference based, at least, on complex mathematical formalisms), which may provide simulated vision, sound recognition and so forth.

As employed herein, the term “processor” may refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor may refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors may exploit nano-scale architectures such as, but not limited to, molecular and quantum-dot based transistors, switches and/or gates, in order to optimize space usage or enhance performance of WRTU. A processor may be implemented as a combination of computing processing units.

As used herein, terms such as “data storage,” “data storage,” “database,” and substantially any other information storage component relevant to operation and functionality of a component, refer to “memory components,” or entities embodied in a “memory” or components comprising the memory. It should be appreciated by one of ordinary skill in the art that the memory components or computer-readable storage media, described herein may be volatile memory or nonvolatile memory or may include both volatile and nonvolatile memory.

What has been described above includes mere examples of various embodiments. It is, of course, not possible to describe every conceivable combination of components or methodologies for purposes of describing these examples, but one of ordinary skill in the art may recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in the detailed description or the claims, such term is intended to be inclusive in a manner similar to the term “comprising” as “comprising” is interpreted when employed as a transitional word in a claim.

A flow diagram may include a “start” and/or “continue” indication. The “start” and “continue” indications reflect that the steps presented may optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than may be recognized by the second item. In a further example of indirect coupling, an action in a first item may cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, may be used in the subject disclosure. For instance, one or more features from one or more embodiments may be combined with one or more features of one or more other embodiments. In one or more embodiments, features that are positively recited may be negatively recited and excluded from the embodiment with or without replacement by another structural and/or functional feature. The steps or functions described with respect to the embodiments of the subject disclosure may be performed in any order. The steps or functions described with respect to the embodiments of the subject disclosure may be performed alone or in combination with other steps or functions of the subject disclosure, as well as from other embodiments or from other steps that have not been described in the subject disclosure. Further, more than or less than all of the features described with respect to an embodiment may be utilized.

What is claimed is:

1. A device, comprising:
a processing system including a processor; and
a memory that stores executable instructions that, when executed by the processing system, facilitate performance of operations, the operations comprising:
determining a user score associated with a first user utilizing a machine learning (ML) software application implementing a first ML model;
receiving a request for an amount of computing resources from a computing device associated with the first user;
determining the amount of computing resources based on a plurality of properties including the user score accessed from a graph database utilizing a second ML model;
identifying allocated computing resources associated with a first virtual machine based on the amount of computing resources utilizing a linear programming software application; and
providing access to the allocated computing resources to the first user via the computing device.

2. The device of claim 1, wherein the determining of the user score comprises determining the user score based on a machine property.

3. The device of claim 1, wherein the determining of the user score comprises determining that the user score is associated with a second user.

4. The device of claim 3, wherein the user score comprises a first user score, wherein the determining of the user score comprises:
determining a second user score associated with the second user; and
determining the first user score based on the second user score.

5. The device of claim 1, wherein the first ML model comprises a DeepAR autoregressive model.

6. The device of claim 1, wherein the linear programming software application implements a linear programming model.

7. The device of claim 6, wherein the linear programming model comprises a min-max optimization model.

8. The device of claim 1, wherein the amount of computing resources comprises at least one of computer processing capacity and memory capacity.

9. The device of claim 1, wherein the allocated computing resources comprises at least one of computer processing capacity and memory capacity.

10. The device of claim 1, wherein the identifying of the allocated computing resources associated with the first virtual machine comprises:
determining an estimated amount of computing resources based on the first user score; and
determining a plurality of available computing resources based on availability of a plurality of virtual machines.

11. The device of claim 10, wherein the identifying of the allocated computing resources associated with the first virtual machine comprises:
identifying first available computing resources associated with the first virtual machine is more than the estimated amount of computing resources, wherein the plurality of available computing resources comprises the first available computing resources, wherein the plurality of virtual machines comprises the first virtual machine; and
determining the allocated computing resources associated with the first virtual machine based on the first available computing resources and the estimated amount of computing resources.

12. The device of claim 11, wherein the plurality of virtual machines is implemented by a plurality of servers.

13. The device of claim 12, wherein the plurality of servers comprises a plurality of cloud servers.

14. A non-transitory machine-readable medium, comprising executable instructions that, when executed by a processing system including a processor, facilitate performance of operations, the operations comprising:
determining a user score associated with a first user utilizing a machine learning (ML) software application implementing a first ML model;
receiving a request for an amount of computing resources from a computing device associated with the first user;
determining the amount of computing resources based on a plurality of properties including the user score accessed from a graph database utilizing a second ML model;
identifying allocated computing resources associated with a first virtual machine based on the amount of computing resources utilizing a linear programming software application; and
providing access to the allocated computing resources to the first user via the computing device.

15. The non-transitory machine-readable medium of claim 14, wherein the determining of the user score comprises the user score based on a machine property.

16. The non-transitory machine-readable medium of claim 15, wherein the first ML model comprises a DeepAR autoregressive model.

17. The non-transitory machine-readable medium of claim 14, wherein the linear programming software application implements a linear programming model.

18. The non-transitory machine-readable medium of claim 17, wherein the linear programming model comprises a min-max optimization model.

19. The non-transitory machine-readable medium of claim 17, wherein the allocated computing resources comprises at least one of computer processing capacity and memory capacity.

20. A method, comprising:
determining, by a processing system including a processor, a user score associated with a first user utilizing a machine learning (ML) software application implementing a first ML model;
receiving, by the processing system, a request for an amount of computing resources from a computing device associated with the first user;
determining, by the processing system, based on a plurality of properties include the user score an estimated amount of computing resources;
determining, by the processing system, a plurality of available computing resources based on availability of a plurality of virtual machines;
identifying, by the processing system, first available computing resources associated with a first virtual machine is more than the estimated amount of computing resources, wherein the plurality of available computing resources comprises the first available computing resources, wherein the plurality of virtual machines comprises the first virtual machine;
determining, by the processing system, allocated computing resources associated with the first virtual machine based on the first available computing resources and the estimated amount of computing resources; and
providing, by the processing system, access to the allocated computing resources to the first user via the computing device.
